(19) United States
(12) Patent Application Publication
(10) Pub. No.: US 2008/0003367 A1
(43) Pub. Date: Jan. 3, 2008

(54) Composition Useful for Providing Nox Removing Coating On Material Surface

(76) Inventor: John Stratton, North East Lincolnshire (GB)

Correspondence Address: KING & SPALDING, 1185 AVENUE OF THE AMERICAS, NEW YORK, NY, 10036-4003, US

(21) Appl. No.: 11/662,484

(22) PCT Filed: Sep. 14, 2004
(86) PCT No.: PCT/IB04/02975

§ 371 Date: Mar. 9, 2007

(51) Int. Cl. C08K 3/22; B05D 3/00

(52) U.S. Cl. 427/372.2; 106/287.1; 524/497

(57) ABSTRACT

The presente invention relates to a composition having photocatalytic self-cleaning properties for use as a NOₓ removing coating on material surface, comprising at least:

a) photocatalytic titanium dioxide particles having at least a de-NOₓ activity,

b) particles having a de-HNO₃ activity, c) an opacifying agent, and d) a silicon based-material in which said particles are dispersed, wherein said photocatalytic particles have a crystalline size ranging from 1 to 50 nm.

The present invention relates to compositions having photocatalytic self-cleaning properties for use as NOₓ removing coating on material surfaces.

In the field of buildings and coatings, the pollution of the environment raises a serious problem of contamination of exterior materials for buildings and outdoor buildings. Dust and particles floating in the air deposit on the roof and the outer wall of buildings in fine weather. Upon exposure to rainfall, the deposits flow together with rainwater and flow down along the outer wall of the building. As a result, the contaminant adheres along the course of the rainwater. As the surface dries, soil appears in a stripe pattern.

To solve at least in part this problem, it has already been proposed to deposit a coating on construction material surfaces. Alternatively, said coating furthermore exhibits photocatalytic self-cleaning properties towards atmospheric contaminants. Thus, titanium oxide photocatalytic coatings are disclosed in EP 0 901 991, WO 97/07069, WO 97/10186 and WO 98/41480.

More specifically, titanium dioxide (TiO₂) which is a semiconductor, converts UV radiation (for example from UV light) into electrons and holes which can ultimately initiate the degradation of harmful organic compounds into harmless substances. Typical atmospheric contaminants are for example, nitrogen oxides, ozone and organic pollutants adsorbed on the coated surface of the materials. This is particularly advantageous in built-up areas, for example, in city streets, where the concentration of organic contaminants may be relatively high, especially in intense sunlight, but where the available surface area of materials is also relatively high.

However, one problem associated with so-formed oxidized species, like HNO₃ formed from the reaction of NO₂ and NO with TiO₂/UV light in the presence of water and oxygen, is their absorption on the coated surface of the material where they may cause problems of stains and/or corrosion.

Accordingly, there is still a need for a coating having a significant improvement in decontamination properties, non staining ability and outstanding durability over prior coatings.

Surprisingly, the inventors have discovered that such a purpose could be efficiently achieved by a specific composition for use as a coating.

Accordingly, an object of the present invention is to provide a composition which, when applied as a coating on a surface of a material, exhibits improved NOₓ and optionally VOCₓ (i.e. Volatile Organic Content like xylene and benzene) removing properties.

Another object of the present invention is to provide a composition which, when applied as a coating on a surface of a material, can easily release the contaminant therefrom in particular by rainfall or by washing with water. Specifically, the composition, when applied to a surface of a substrate to form a film, enables a contaminant or derivative thereof adhered onto the surface to be easily washed away by water.

According to one aspect, the instant invention is directed to a NOₓ removing composition for use as a opaque coating on construction material surfaces, comprising at least:

a) photocatalytic titanium dioxide particles having at least a de-NOₓ activity,

b) particles having a de-HNO₃ activity,

c) an opacifying agent, and

d) a silicon based-material, in which are dispersed said particles, wherein said photocatalytic particles have a crystalline size ranging from 1 to 50 nm.

According to another aspect, the instant invention relates to a method for imparting self-cleaning properties towards atmospheric contaminants at the surface of a material, said method comprising at least the steps of:
applying a composition according to the invention onto the surface of a material,
drying or curing the said composition to provide an opaque coating system.

The coating obtained according to the present invention, in particular after having been exposed to water and UV light, exhibits high durability and de-NO₃ efficiency as shown here-after in the examples.

Photocatalytic Titanium Dioxide Particles:

The composition according to the present invention comprises at least dispersed photocatalytic titanium dioxide particles having at least a de-NOₓ activity with NOₓ meaning NO and/or NO₂. According to a specific embodiment, said photocatalytic particles also exhibit a de-VOC activity.

The term “de-NOₓ and/or de-VOC” activity as used herein refers to an ability to transform NOₓ and/or VOC species to their respective oxidized species like HNO₃ for NOₓ.

Specifically, in the present invention, the term “photocatalytic particles” used herein refers to particles based on a material which, when exposed to light (excitation light) having higher energy (i.e., shorter wavelength) than the energy gap between the conduction band and the valence band of the crystal, can cause excitation (photoexcitation) of electrons in the valence band to produce a conduction electron and a valence hole.

The photocatalytic titanium dioxide particles contained in the composition according to the present invention basically include anatase or rutile forms of titanium oxide and mixtures thereof.

For example, the titanium dioxide particles of the coating, the nature of the particle may be predominantly the anatase crystalline form. “Predominantly” means that the level of anatase in the titanium dioxide particles of the coating composition is greater than 50% by mass. The particles of the coating composition may exhibit a level of anatase of greater than 80%.

The degree of crystallization and the nature of the crystalline phase are measured by X-ray diffraction.

The crystalline titanium dioxide particles incorporated in the coating exhibit a mean size ranging from 1 to 300 nm, preferably ranging from 2 to 100 μm, more preferably still from 5 to 50 μm. The diameters are measured by transmission electron microscopy (TEM) and also XRD.

The preferred photocatalyst particles have a high surface area per gram, e.g., higher than 50 m²/g and preferably above 100 m²/g as measured by the BET method.

In contrast, the surface area per gram of conventional TiO₂ pigments i.e. having photocatalytic properties is about 1-30 m²/g. The difference in the much smaller particles and crystallites of the photocatalyst particles, gives rise to a much higher surface area.

Particularly convenient for the invention, are the photocatalytic TiO₂ sold, e.g. S5-300 A and B sold by Millennium Inorganic Chemicals Ltd or a proprietary neutral sol.

The particles having a photocatalytic activity are added in an amount of 0.1 to 25%, preferably 0.5 to 20%, and most preferably 1 to 15%, by weight (expressed in dry matter) of the total weight of said composition.

In particular, the composition according to the invention includes at least 1% by weight of photocatalytic particles.

According to a specific embodiment, photocatalytic particles may also exhibit a de-VOC removing property.

The photocatalytic titanium dioxide particles may be used as a sol prepared by dispersion in water, as a water- or solvent-containing paste, or as a powder. Preferred examples of the dispersant used to prepare a sol include water, alcohols such as methanol, ethanol, isopropanol, n-butanol and isobutanol, and ketones such as methyl ethyl ketone and methyl isobutyl ketone.

De-HNO₃ Particles:

The composition according to the present invention comprises dispersed particles for removing the oxidized species HNO₃, formed photocatalytically from NOₓ particles. These second type of particles are called “HNO₃ removing particles” or de-HNO₃ particles.

Illustrative examples of de-HNO₃ particles include basic compounds, in particular any insoluble carbonates and for example calcium carbonate, zinc carbonate, magnesium carbonate and mixtures thereof. Especially, preferred examples of such compounds include calcium carbonate. No particular limitation is imposed on its amount which should be sufficient to achieve the transformation of HNO₃ to its alkaline salt and, secondary, compatible with the coating including it. An amount of 0.05 to 50%, in particular of 0.1 to 30%, by weight (expressed in dry matter) of the total weight of said composition may be particularly convenient.

The ratio de-HNO₃ particles/photocatalytic particles may vary from 0.05 to 5, in particular from 0.1 to 3 and more particularly from 0.2 to 2.0.

Said particles i.e. de-HNO₃ particles and photocatalytic particles are included in the composition according to the invention in an amount greater than 1% by weight (expressed in dry matter), in particular lower than 50% and more particularly lower than 35% by weight of the total weight of the composition.

Silicon-Based Component:

The composition of the present invention contains a silicon-based component wherein at least previously disclosed particles are entrapped.

Specifically, in the present invention, the term “silicon-based material” used herein refers to any material based on silica or mixture thereof, which is able to provide a silicon based-film convenient for coating.

The silicon based-material advantageously provides a polysiloxane polymer film.

According to one embodiment, the silicon based-material includes at least one polysiloxane derivative and in particular having the formula 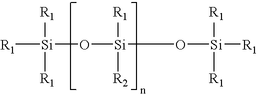
wherein
n has a value to provide an aqueous dispersion of polysiloxane having weight percentage solid ranging from 40-70%, and
R₁ and R₂ are alkyl radicals of 1 to 20 carbon atoms or an aryl group such as phenyl.

Typically, the value of n ranges from about 5 to 2000.

Illustrative R₁ and R₂ radicals are alkyl groups (e.g., methyl, ethyl, propyl, butyl, 2-ethylbutyl, octyl), cycloaklyl groups (e.g., cyclohexyl, cyclopentyl), alkenyl groups (e.g., vinyl, hexenyl, allyl), aryl groups (e.g., phenyl, tolyl, xylyl, naphthyl, diphenyl) aralkyl groups (e.g., benzyl, phenylethyl), any of the foregoing groups in which some or all of the hydrogens bonded to the carbons have been substituted (such as with halogen atoms or cyano), or groups substituted with or containing, for example, amino groups, ether groups (—O—), carbonyl groups (—CO—), carboxyl groups (—COOH) or sulfonyl groups (—SO₂—) (e.g., chloromethyl, trifluoropropyl, 2-cyanoethyl, 3-cyanopropyl). In particular, the molecular weight of the polysiloxane ranges from 500 to 5000, in particular from 1500 to 5000.

Particularly convenient for the instant invention care, polysiloxanes sold under the trademark WACKER BS 45 by the firm WACKER-Chemie GmbH.

The content of the polysiloxane in the composition according to the present invention may be suitably determined. According to a specific embodiment, it may ranges from 1 to 60% by weight in particular from 5 to 50% by weight (expressed in dry matter) of the total weight of the composition.

According to a specific embodiment, the composition according to the invention may also contain an organic binder.

Organic Binder:

The organic binder may be chosen among copolymers of styrene/butadiene, and polymers and copolymers of esters of acrylic acid and in particular copolymers of polyvinylacrylic and styrene/acrylic esters.

In the present invention, styrene acrylic copolymer includes copolymers of styrene/acrylic esters thereof.

The inventors have unexpectedly discovered that such a compound was particularly advantageous to obtain a photocatalytically active coating having a high de-NOₓ efficiency.

Such effect was in particular noticed where this compound is a styrene/acrylic copolymer and more particularly used in a weight ratio of photocatalytic TiO₂ particles/organic binder and in particular styrene/acrylic copolymer ranging from 0.3 to 4.5, in particular from 0.5 to 3.6, more particularly from 1 to 3.5.

In particular, a styrene acrylic emulsion such as ACRONAL 290D from BASF GmbH may be used.

When the composition includes an organic binder, it is preferably introduced in place of a part of the silicone based-material.

The composition may have a weight ratio of silicone based-material/organic binder ranging from 20 to 1.

Opacifying Agents

According to the invention, the opacifying agent includes any organic or inorganic compound able to provide hiding power to the coating. It includes pigments, colorants and/or fillers as listed hereafter. More preferably, it includes at least one inorganic compound like titanium dioxide, either rutile or anastase.

Such titanium dioxide pigments which are not photoactive are disclosed in U.S. Pat. No. 6,342,099 (Millennium Inorganic Chemicals Inc.).

In particular, the particles of Tiona 595 and/or the particles of Tiona AT-1 sold by Millennium Inorganic Chemicals Ltd may be used.

The composition may contain such an opacifying agent in an amount ranging from 0.5 to 20% by weight in particular from 0.5 to 35% by weight.

The composition according to the present invention may include at least a solvent.

Examples of solvents usable herein include water, an organic solvent, and a mixed solvent composed of water and an organic solvent. Water, and alcohol is particularly preferred.

The composition according to the present invention may contain optional components provided that such an addition does not compromise the shelflife, UV durability, opacity or non-staining properties. Examples of such additional compounds include filler(s) like quartz, calcite, clay, talc, barite and/or Na—Al-silicate; pigments like TiO₂, lithopone, and other inorganic pigments; dispersants like polyphosphates, polyacrylates, phosphonates, naphthene and lignin sulfonates; wetting agents like anionic, cationic, amphoteric and non-ionic surfactants; defoamers like silicon emulsions, hydrocarbons, long-chain alcohols; stabilizers like mostly cationic compounds; coalescents agents like alkali-stable esters, glycols, hydrocarbons; rheological additives like cellulose derivatives (CMC, HEC), xanthane gum, polyurethane, polyacrylate, modified starch, bentone and other lamellar silicates; water repellents like alkyl siliconates, siloxanes, wax emulsion, fatty acid Li salts and conventional fungicides or biocides.

The composition of the present invention may be applied onto the surface of the material by any suitable method, and examples of suitable methods include spray coating, dip coating, flow coating, spin coating, roll coating, brush coating, and sponge coating.

The composition after the application onto the surface of the substrate is then dried or cured to form a thin film. The term “dried or cured” used herein means that the silicon based-material contained in the composition according to the present invention is converted to a silicon-based film. Therefore, drying may be performed by either air drying or heat drying. Alternatively, ultraviolet irradiation or the like may be conducted to cause polymerization so far as the precursor is converted to a silicon film.

The composition according to the present invention may be applied on the surface of a high variety of materials.

The material is not particularly limited, and examples thereof include metals, ceramics, glasses, plastics, woods, stones, cements, concretes, fibers, woven fabrics, and combinations of the above materials and laminates of the above materials. Specific examples to which the composition may be applied include housing, building materials; exterior of the buildings; interior of the buildings; sashes; windowpanes; structural materials; exterior of machineries and articles; dustproof covers and coatings; films, sheets, seals; tunnel and parking areas.

In preparing the preferred embodiments of the present invention, various alternatives may be used to facilitate the objectives of the invention.

The following examples are presented to aid in an understanding of the present invention and are not intended to, and should not be construed to limit the invention in any way. All alternatives, modifications and equivalents which may becomes obvious to those of ordinary skill in the art upon a reading of the present disclosure are included within the spirit and scope of the invention.

### EXAMPLES

Compositions were prepared by using the following materials:
photocatalytic titanium dioxide: PC 105 (42% TiO₂ by weight in water containing 1% of sodium hexametaphosphate) from Millennium Inorganic Chemicals,
titanium dioxide pigments: Tiona 595 from Millennium Inorganic Chemicals,
calcium carbonate (filler) Snowcal 60 from Omya Ltd.
Hydroxy ethyl cellulose Natrosol 250 MR from Hercules Incorporated 3% solution in water,
Wacker BS45: Polysiloxane polymer latex from Wacker Chemie GmbH,
Texanol: 2, 2, 4 trimethyl-1,3 pentanediol monoisobutyrate from Eastman Chemical Company,
Sodium salt of polyacrylic acid: Dispex N40 from Allied Colloids Ltd.

The paints are prepared in three parts termed A, B & C.

For part A, the TiO₂ is added to water to which is then added Natrosol 250MR, Dipex N40 and Snowcal-60.

The components are mixed under high shear.

For part B, the polysiloxane polymer is added to part A and then part C, the Texanol is added to parts A and B.

The compositions of so-prepared paints are listed in Table I.

TABLE I

| | F₁ | F₂ |
|---|---|---|
| PART A | | |
| Photocatalytic TiO₂* (% wt) | 23 | 20 |
| CaCO₃* (% wt) | 9.8 | 19.9 |
| Opacifying agent (TiO₂) | 14.6 | 12.6 |
| Salt of polyacrylic | 0.7 | 0.6 |
| (% wt) | | |
| Hydroxyethyl cellulose | 16.6 | 16.7 |
| (% wt) | | |
| Water | 2.2 | 11.1 |
| (% wt) | | |
| PART B | | |
| Polysiloxane (% wt) | 31.5 | 18.2 |
| Part C | | |
| Texanol | 1.6 | 0.9 |
| (% w) | | |

The percentages stated in the table are the percentages expressed in commercial product i.e. dry matter + solvent.

Method for Determination of Coating Photoactivity Towards Methylene Blue

Irradiating Titanium dioxide with Ultra Violet light results in the production of holes and electrons which are then capable of forming reactive species such peroxide, hydroperoxide and hydroxyl ions. These are then capable of oxidising organic molecules such as methylene blue to water, carbon dioxide and nitrogen containing species with the associated loss of colour. The level of photoactivity is monitored by measuring the L* (brightness) and b* value (blue/yellowness).

The method is most suitable for coatings that are wetted with water such as latex or emulsion paints. The porosity of the coatings will affect the amount of stain that the films will pick up but this is minimised by the addition of a thickener to the methylene blue solution. There may also be colour changes of the blue due to pH effects.

Preparation of Methylene Blue Solution

The methylene blue is first dissolved in de-mineralised water to a concentration of 0.05% by weight. Using slow speed stirring the equivalent of 1% Natrasol MR® (Hydroxy Ethyl Cellulose) is then added. In order for the Natrosol to hydrate, the pH is raised to approximately 8.0 with dilute ammonia. This requires only a few drops. The solution is stirred for a further hour to completely hydrate the Natrosol.

Paint Film Staining

The paint film to be tested is over-coated with a film of the methylene blue solution by drawing down a film using a spiral wound rod. The test film has previously been prepared by applying a wet paint film to 30 microns thick Melinex or Mylar sheet. The spiral wound rods are specified to give various film thicknesses but those giving 25 to 50 microns wet film are generally employed. The coatings are left to dry at 23 deg C. 50% RH overnight.

Measurement

A suitable sized area of the coatings is cut from the film and the L* and b* measurements are made using a Spectrophotometer. The paint films are then exposed to light from an Atlas Suntest machine set to give a light output of 551 W/m² from 250 to 765 nm. The paint films are re-measured at suitable intervals, typically 18 to 24 hours.

The difference in L* and b* between the unexposed and exposed results is a measure of the photoactivity of the coating towards self-cleaning.

The data are provided in the following table.

TABLE II

| | ΔL* | Δb* |
|---|---|---|
| F1 | 2.8 | 3.1 |
| F2 | 3.6 | 3.8 |

Method for Determination of Durability

The durability of the coatings was assessed by preparing coatings on stainless steel panels and exposing them to simulated weathering conditions in a machine designed for that application. The amount of weight which the coating losses during the exposure was a measure of its durability.

The stainless steel panels measure 75 by 150 mm and were 0.75 mm thick. The panels were weighed to 0.0001 g before and after application of the paint film so that the weight of the coating can be calculated.

The panels can be coated by any convenient means including brushing, spraying, spinning or by spiral rod applicator. Only the surface to be exposed was coated. The dry film thickness was typically in the range of 20 to 50 microns.

The coatings were left to dry for 7 days before exposure in the Weatherometer.

The Weatherometer used for the exposures was a Ci65A made by Atlas Electric Devices, Chicago. The light source was a 6.5 kW Xenon source emitting 0.5 W/m² UV at 340 nm. The black panel temperature was 63 degrees Celsius. Water spray was applied for 18 minutes out of every 120 minutes and there was no dark cycle.

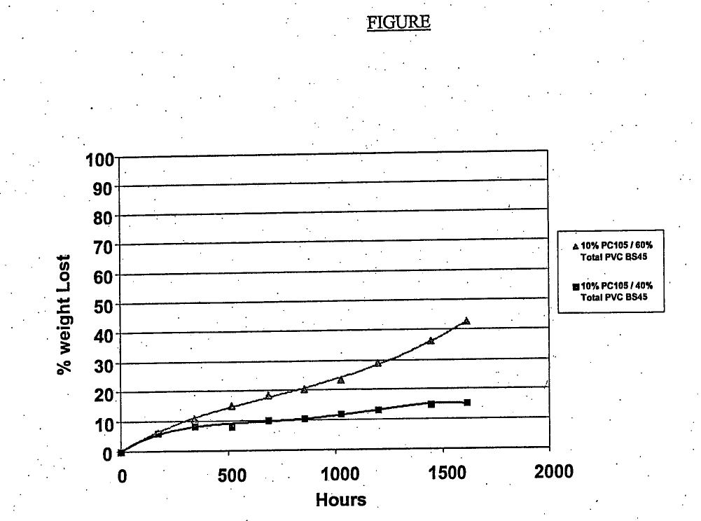

The so-obtained values are submitted in the FIG. 1. They show that only about 15 or 38% by weight of the initial total weight of the coating obtained from F1 and F2 according to the invention have been lost after 1500 hours exposure.

Determining of NO/NO₂ Removal by Coatings

The paint films were irradiated with 0.5 W/m² UV at 340 nm for 168 hours using a filtered Xenon light source (Atlas Weatherometer Ci65A) before carrying out the test. This either activates or increases the activity of the coatings over and above the unexposed coatings. For the NOₓ measurements, the samples were irradiated with a UV fluorescent tube which emits 10 W/m² UV in the range of 300 to 400 nm. The NOₓ that is used is NO at 225 ppb in nitrogen.

1. Equipment

Nitrogen Oxides Analyser Model ML9841B
ex Monitor Europe

UV Lamp Model VL-6LM 365 & 312 nanometer wavelength
ex BDH

Air-tight sample chamber

3 channel gas mixer
ex Brooks Instruments, Holland

2. Gases

NO Nitric Oxide

Compressed air containing water vapour to give 50% Relative Humidity in mixed gas stream.

3. Method

1. Switch on Analyser and exhaust pump. Ensure exhaust pipe goes to atmosphere.

2. Allow to warm-up. Several internal components need to reach operating temperature before the analyser will begin operation. The process will, typically, take 60 mins from cold start and the message START-UP SEQUENCE ACTIVE will be displayed until operating conditions are met.

3. After warm-up turn on air and test gas supply to the gas mixer.

4. Calibrate the Analyser on the Test gas supply only, (turn the air channel to zero on the gas mixer), according to the manufacturer's instructions.

5. After calibration turn OFF the test gas supply at the gas mixer.

6. Place test sample in the test chamber and seal chamber.

7. Turn on both air and test gas and adjust each until required level of test gas is reached, shown by the Analyser output. RECORD level. Check that the Relative Humidity is 50% within plus or minus 5%.

8. Switch on the UV lamp when test gas levels are at desired point.

9. Allow the irradiated sample value to reach equilibrium, typically up to 3 mins.

10. RECORD the value shown on the analyser.

11. Report “Initial Value” i.e. no UV, “Final Value” after UV exposure for set period.

12.

$$\% NO \times Removed = \frac{INITIAL VALUE - FINAL VALUE * 100}{INITIAL VALUE}$$

The data are provided in the following table.

| | % NO removal |
|---|---|
| F₁ | 0.5 |
| F₂ | 47.0 |

1. A NOₓ removing composition for use as a coating on material surface, comprising at least:
a) photocatalytic titanium dioxide particles having at least a de-NOₓ activity,
b) particles having a de-HNO₃ activity,
c) an opacifying agent, and
d) a silicon based-material in which said particles are dispersed,
wherein said photocatalytic particles have a crystalline size ranging from 1 to 50 nm.

2. The composition according to claim 1, wherein photocatalytic particles include at least anatase form of titanium dioxide, rutile form of titanium oxide or a mixture thereof.

3. The composition according to claim 1, wherein the titanium dioxide particles are predominantly the anatase crystalline form.

4. The composition according to claim 3, wherein the crystalline titanium dioxide particles exhibit a mean size from 1 to 300 nm, in particular from 2 to 100 nm, more particularly from 5 to 50 nm.

5. The composition according to claim 1, wherein the photocatalytic particles have a surface area per gram higher than 5 m²/g.

6. The composition according to claim 1, wherein the photocatalytic particles are present in an amount of 0.1 to 25%, preferably 0.5 to 20%, and most preferably 1 to 15% by weight (expressed in dry matter) of the total weight of said composition.

7. The composition according to claim 1, wherein de-HNO₃ particles include basic compounds.

8. The composition according to claim 7, wherein de-HNO₃ particles include calcium carbonate, zinc carbonate or a mixture thereof.

9. The composition according to claim 8, wherein the de-HNO₃ particles are present in an amount of 0.05 to 50%, in particular of 0.1 to 30% by weight of the total weight of said composition.

10. The composition according to claim 1, wherein it includes photocatalytic titanium dioxide and de-HNO₃ particles in a ratio de-HNO₃ particles/titanium dioxide particles ranging from 0.05 to 5, in particular from 0.1 to 3, and more particularly from 0.2 to 2.

11. The composition according to claim 1, wherein the silicon based-material provides a polysiloxane film.

12. The composition according to claim 1, wherein the silicon based-material includes at least a polysiloxane polymer.

13. The composition according to claim 1, wherein the opacifying agent is based on anatase or rutile TiO₂ particles.

14. The composition according to claim 1, wherein the particles of a) and b) are present in an amount lower than 50% by weight of the total weight of said composition.

15. The composition according to claim 1 furthermore including an organic binder.

16. The composition according to claim 15, wherein the organic binder is selected from the group consisting of polyvinylacrylic and copolymers of styrene/(meth)acrylic esters.

17. A method for imparting self-cleaning properties towards atmospheric contaminants to a surface of a material, said method comprising at least the steps of:
applying a composition according to claim 1 onto the surface of a material, and
drying or curing the composition to obtain an opaque coating thereon.
